(19) United States
(12) Patent Application Publication
(10) Pub. No.: US 2001/0048180 A1
(43) Pub. Date: Dec. 6, 2001

(54) GOLF BALL MOLD CAVITY WITH SUBGATES

(76) Inventor: VAL J. CUPPLES, CANYON LAKE, CA (US)

Correspondence Address: CALLAWAY GOLF C0MPANY, 2285 RUTHERFORD ROAD, CARLSBAD, CA, 92008

(21) Appl. No.: 09/333,757

(22) Filed: Jun. 15, 1999

(51) Int. Cl. B29C 45/14; B29C 45/27

(52) U.S. Cl. 264/275; 264/278; 264/279.1; 264/328.12; 425/120; 425/121; 425/125; 425/129.1; 425/573; 425/577

(57) ABSTRACT

A injection molding device for manufacturing golf balls is disclosed. The device includes first and second hemispherical mold halves that form an interior cavity where the injection molding process occurs. A plurality of retractable pins are preferably used to support a core within the mold cavity. The first and second mold halves further include a plurality of subgates. The subgates are connected to a runner system for delivery of a fluid stock material into the void of the cavity. The plurality of subgates includes a first and second set of subgates. The first set of subgates and the second set of subgates enter the respective cavities at an angle between 30 and 40 degrees to the parting line.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The field of the invention relates generally to injection mold devices. More specifically, the invention relates to injection mold-devices used for the manufacturing of golf balls.

2. Description of the Related Art

Golf balls generally have either a one-piece construction or they may comprise several layers including a core, one or more intermediate layers and an outer cover that surrounds any intermediate layer and the core.

Golf balls are typically manufactured by various molding processes, whether one-component or multi-component balls. Generally, the core of the golf ball is formed by casting, compression molding, injection molding or the like. If an intermediate boundary layer is desired, one or more intermediate boundary layers are added over the core by any number of molding operations, including casting, compression molding, and/or injection molding. The cover is then formed over the core and intermediate boundary layers, if present, through casting, compression molding, or injection molding.

In an injection molding process, golf balls are typically created by the injection molding of a fluid stock material around a pre-formed core. In the case of a two-component golf ball, the fluid stock material is the cover material used for the golf ball. The injection molding process is also suitable for golf balls having one or more intermediate layers disposed between the core and the cover. Injection molding devices generally have two separate and mating hemispheric halves that form a cavity in which the golf ball is created. The injection mold also includes a plurality of retractable pins that hold the core in place while the fluid stock (intermediate layer material or cover material) fills the void between the core and the inside walls of the hemispheric mold halves. After the fluid stock of interest has finished entering this void and before the fluid stock has completely hardened, the retractable pins are withdrawn, and the fluid stock material fills the voids created by the retractable pins.

Fluid stock material is generally fed to the cavity within the mold through one or more conduits, or “runners” as they are commonly referred to in the art. The fluid stock material travelling through the runners enters the actual cavity of the mold via one or more gates. These gates are typically positioned at the parting line created between the interface of the two mold halves. Locating the gates at the parting line, however, results in unwanted material being left on the newly formed golf ball at the parting line. For example, flashing can occur along the equatorial region of the golf ball. In addition, when the gates are located at the parting line of the mold, vestigial stock material located inside the gates of the molding device is attached to the surface of the ball after the mold halves are pulled apart. Additional finishing processes are then required to remove the flashing and any excess material. Not only does this increase the number of steps required for forming a golf ball, it also can interfere with the dimple pattern on the surface of the golf ball, thereby affecting the performance characteristics of the golf ball.

By locating the gates in the parting line of the ball, the core tends to undergo deleterious deformation during the injection molding process. This problem is caused by the high pressure that is inherent in the injection molding process. The deformation is particularly problematic at the locations on the core where the fluid entering the gate impinges upon the core. This can be reduced to a certain extent by increasing the total number of gates in the mold.

Another deformation problem can result from high pressure forces generated during the injection molding process. In devices incorporating a plurality of gates located at the parting line, the core tends to constrict in the equatorial region and expand in the polar region. This deformation, or bulge, creates asymmetrical cores which can affect the performance of the golf ball. Moreover, an uneven void is created between the outer surface of the core and the inner surface of the mold. The flow of fluid stock to the poles of the mold is thus restricted. This restriction can create non-uniform covers or intermediate layers surrounding the core. In addition, the restricted flow to the poles of the mold also increases the amount of time that is required for each injection molding process. The bulging problem is particularly problematic when a thin intermediate layer or cover is desired since any bulging of the core may completely close off a portion of the void created between the core and the inner surface of the mold. In this case, fluid stock material is unable to reach certain areas of the core surface to create a non-fill condition.

U.S. Pat. No. 5,147,657, ('657 patent) issued to Giza discloses a mold device having an improved retractable pin mechanism. The mold includes two gates positioned at each pole of the mold cavity. See, e.g., FIG. 2 of '657 patent. This makes balancing less critical and reduces shifting of the core during molding operations.

As another example, U.S. Pat. No. 5,112,556 ('556 patent), issued to Miller discloses a molding apparatus for the manufacture of golf balls. The '556 patent discloses a mold that has an alignment means in the form of mating inclined surfaces for precise alignment of the mold halves during operation. In addition, one or more gates are positioned at one or more poles of the mold cavity so that no cold runners or flashings are formed on the golf ball that would require removal.

U.S. Pat. No. 5,122,046 ('046 patent), issued to Lavallee et al. discloses an injection mold device for a two-piece golf ball which, when removed form the mold, does not have any gate vestige and has only a minimal flashline around the ball. The mold of the '046 patent uses a plurality of tunnel gates on one of the hemispherical surfaces, wherein the tunnel gates are vertically offset from the parting line of the mold. See FIG. 3 of '046 patent.

U.S. Pat. No. 5,892,567 ('567 patent), issued to Cavallaro et al. discloses a method of making a golf ball having multiple layers. The '567 patent further discloses an injection molding device for forming golf balls. The injection molding device includes a mold having either edge gates (FIGS. 1 and 2), or sub-gates (FIG. 2(a)). The '567 patent teaches that edge gates allow the final golf balls to be connected and removed from the mold together. Sub-gating, on the other hand, automatically separates the mold runner from the golf balls during the ejection of the golf balls from the mold.

These and other current golf ball manufacturing processes continue to suffer from a number of disadvantages. For example, the use of polar gates still causes the core of the ball to undergo deformation. In these instances, a bulging of the core is created at the equatorial region of the core rather than at the poles. This can cause not only deformation of the core, but also constriction of the void space between the core and the interior of the mold.

In the mold device disclosed in the '046 patent, the gates are vertically offset from the parting line of the mold to reduce flashing and eliminate gate vestiges. However, the gates are still oriented perpendicularly to an imaginary tangent line drawn on the surface of the core or the interior of the mold cavity. In this regard, the orientation of the gates creates a large degree of pressure around the equatorial region of the core. Moreover, the perpendicular (i.e., normal to a tangent line drawn at the surface of the core) orientation of the gates to the surface of the core creates localized deformations at the points of impact where the fluidized stock material impinges upon the core or intermediate layer. In addition, the gates are located on one halve of the hemispheric mold, thus causing asymmetrical deformation of the core.

The '567 patent discloses the use of sub-gates that enter the mold at a location away from the parting line. However, the sub-gates of the '567 patent are located on one side of the mold. As recited above, this causes asymmetrical deformation of the golf ball core during the injection molding process. The use of sub-gates on only one side of the injection mold can also result in the total failure of the injection molding process. Due to the high pressure conditions of the injection molding process, the golf ball core can be forced against the mold halve that is opposite the sub-gates. Even the presence of pins cannot keep the core in place, since the pins protrude into the core during the injection of the fluid stock material. In addition, as can be seen from FIG. 2(a) of the '567 patent, the sub-gates are oriented perpendicularly to the surface of the core. As with the '046 patent, this orientation creates a large amount of pressure at the equatorial region of the core as well as localized deformation at the points of impact. Consequently, there remains a need for an injection molding device that does not create the unwanted bulging of the core during formation of any intermediate layer or outer cover. Even where minor bulging of the core is unavoidable, it is preferably to keep such deformations as symmetrical as possible such that the performance characteristics of the golf ball are not adversely impacted. In addition, the gate configuration should permit the fluid stock material to flow readily to both the polar and equatorial regions of the ball, even when a thin cover or intermediate layer is being formed.

### BRIEF SUMMARY OF THE INVENTION

One aspect of the present invention is an injection mold device for molding a layer on a golf ball. The injection mold device has a mold having a substantially spherical internal cavity defined by an internal surface of the mold. The mold has a plurality of subgates, each of the plurality of subgates having an inlet and an outlet. The outlet of each of the plurality of subgates is located a predetermined length from a parting line of the mold. Each outlet is in flow communication with the internal cavity. Each of the plurality of subgates is oriented at a predetermined angle with respect to the parting line.

Another aspect of the present invention is an injection mold device for manufacturing a golf ball. The injection mold device has a first mold halve and a second mold halve. The first mold halve has a concave surface defining a first hemispherical cavity. The concave surface has an equatorial rim defining the top of the first hemispherical cavity and an inverse pole defining the bottom of the first hemispherical cavity. The first mold halve also has a first plurality of subgates, each having an inlet and an outlet. The outlet of each of the first plurality of subgates is located a predetermined length from the equatorial rim. Each outlet is in flow communication with the first hemispherical cavity. Each of the first plurality of subgates is oriented at an angle between 30 and 40 degrees with respect to the equatorial rim. The second hemispherical mold halve opposes the first hemispherical mold halve. The second hemispherical mold halve has a concave surface defining a second hemispherical cavity. The concave surface has an equatorial rim defining the top of the hemispherical cavity and an inverse pole defining the bottom of the hemispherical cavity. The second hemispherical mold halve has a second plurality of subgates. Each of the second plurality of subgates has an inlet and an outlet. The outlet of each of the second plurality of subgates is located a predetermined length from the equatorial rim. Each outlet is in flow communication with the hemispherical cavity. Each of the second plurality of subgates is oriented at an angle between 30 and 40 degrees with respect to the equatorial rim.

Yet another aspect of the present invention is a method for molding a layer for a golf ball. The method includes injecting a flowable material about a golf ball precursor product disposed within an internal cavity of a mold. The mold includes a first hemispherical mold halve and an opposing second hemispherical mold halve. The flowable material is injected through a plurality of subgates located a predetermined distance from a parting line defining the meeting of the first and second hemispherical mold halves. Each of the plurality of subgates is oriented at an angle between 30 and 40 degrees relative to the parting line.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF SEVERAL VIEWS OF THE DRAWINGS

FIG. 1 is a cut-away view of a golf ball having a core, an intermediate layer, and a cover.

FIG. 2 is a cross-sectional view of an injection molding device according to the prior art.

FIG. 3 is a schematic representation of a core undergoing deformation, or bulging, within an injection mold cavity of the prior art.

FIG. 4 is a perspective view of a mold of the present invention.

FIG. 5 is a cross-sectional view of the mold of FIG. 4.

FIG. 5A is a cross-sectional view of an alternative embodiment of the mold of FIG. 4.

FIG. 6 is a top plan view of a mold halve of the present invention.

FIG. 7 is an isolated view of a subgate of the present invention.

FIG. 8 is an isolated view of a portion of a mold halve illustrating a single subgate.

FIG. 9 is a top plan view of a mold base for the present invention.

FIG. 10 is a cross-sectional view of a mold of the present invention during one stage of a molding operation.

FIG. 11 is a cross-sectional view of a mold of the present invention during a second stage of a molding operation.

FIG. 12 is a cross-sectional view of a mold of the present invention during a third stage of a molding operation.

FIG. 13 is a cross-sectional view of a mold of the present invention during a fourth stage of a molding operation.

FIG. 14 is a perspective view of a molded golf ball product of the present invention.

FIG. 15 is a perspective view of a molded golf ball product of the prior art.

### DETAILED DESCRIPTION OF THE INVENTION

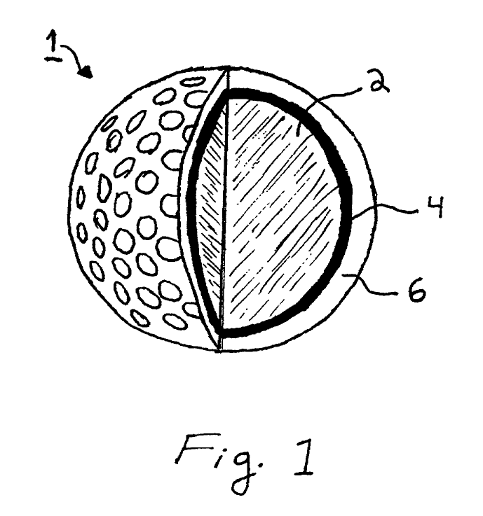

As shown in FIG. 1, a golf ball 1 generally comprises a two-piece construction or it may include several layers including a core 2 and an outer cover 6 surrounding the core 2. Optionally, the golf ball 1 may include one or more intermediate layers 4 (as shown in FIG. 1) disposed between the core 2 and the outer cover 6.

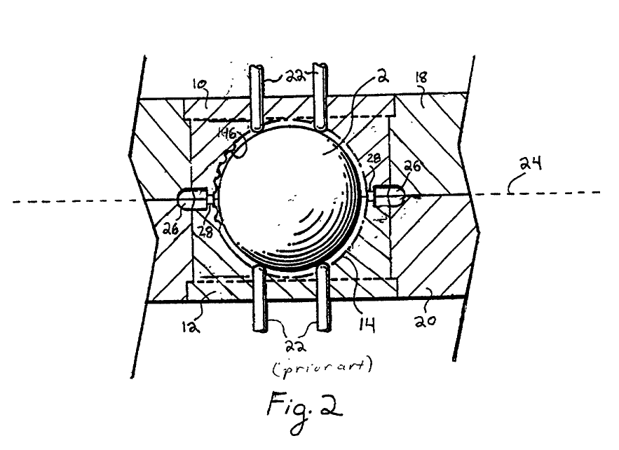

Referring now to FIG. 2, a description of an injection molding device according the prior art will now be given. Typically, the molding device includes two separate hemispheric mold halves 10, 12. The two hemispheric mold halves 10, 12 join to form a cavity 14 in which the injection molding process takes place. The interior of the cavity 14 is lined with a plurality of protuberances 16 which form the dimples on the outside of the golf ball 1. Both hemispheric mold halves 10, 12 are held in place typically through the use of platens 18, 20 and the like. Also included are a plurality of retractable pins 22. The retractable pins 22 extend into the cavity 14 and are used to hold the core 2 in place during the injection molding operation.

When engaged together, the hemispheric mold halves 10, 12 combine into a mating configuration, as shown in FIG. 2. A parting line 24 is thus created at the interface of the two hemispheric mold halves 10, 12. The molding device also includes a runner 26 that acts as a conduit for the fluidized stock material (not shown) that is to be injected into the molding device. Connected to the runner 26 are a plurality of gates 28. As shown in FIG. 2, the gates 28 are located in the parting line 24. The gates 28 provide passageways from the runner 26 to the interior of the cavity 14.

During operation, the core 2 is placed in the cavity 14 formed inside the hemispheric mold halves 10, 12. The core 2 is supported by the plurality of retractable pins 22. For formation of the cover 6 of the golf ball 1, a heated fluid stock (not shown) that is typically under pressure is forced into mold cavity 14. The fluid stock passes through the runner 26 and plurality of gates 28 into the void created between the core 2 and the inner surface of the cavity 14. The fluid stock then travels from the equatorial region of the core 2 to the polar region. As the fluid stock begins to harden, the retractable pins 22 are retracted and the fluid stock is allowed to occupy the void left by the retractable pins 22. The two hemispherical mold halves 10, 12 are released from their mating engagement and the golf ball 1 is released.

In the molding device shown in FIG. 2, since the gates are disposed about the parting line 24, vestigial remnants of the fluid stock material within the gates 28 remain attached to the golf ball 1. Additional processes must be employed to remove this unwanted material. Even if this material can be removed, the golf ball 1 often has imperfections and artifacts that interfere with the dimple pattern formed on the surface of the golf ball 1. In addition, these imperfections and artifacts adversely impact the flight characteristics of the golf ball 1.

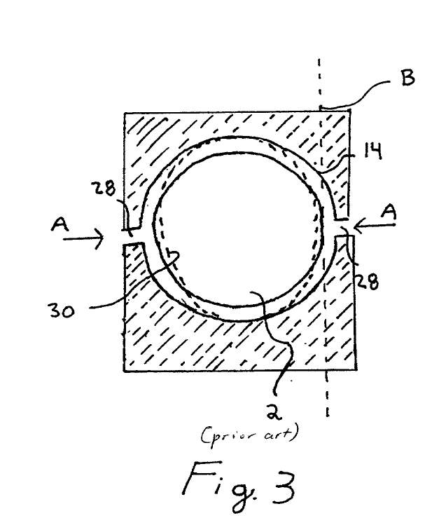

FIG. 3 shows schematically the bulging of the core 2 that is common in prior art injection mold devices. This bulging is due to the placement of a plurality of gates 28 around the parting line 24 region. In this design, fluid stock material flows into the cavity 14 in the direction of arrows A. The fluid stock flow then impacts the core 2 surface perpendicularly (i.e., perpendicular to an imaginary tangent line B drawn at the surface of the core 2). This creates a large amount of pressure on the core 2 in the equatorial region. Due to this pressure, the core 2 undergoes bulging as shown by dashed line 29. This bulging 29 can result in the core 2 pinching-off the void area between the core 2 and the cavity 14. In this condition, the fluid stock cannot flow to the polar region of the core 2. This problem is particularly acute when a relatively thin cover 2 or intermediate layer 4 is formed on the core 2. This is because the void created between the core 2 and the cavity 14 is relatively small and any distortions to the core 2 can easily pinch-off regions from the injection molding process.

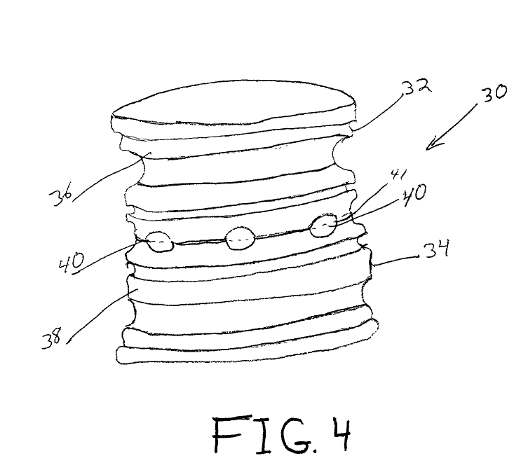

As shown in FIG. 4, a golf ball mold of the present invention is generally designated 30. The mold 30 generally includes a first hemispherical mold halve 32 and a second hemispherical mold halve 34. One of the mold halves may be the top mold halve while the other represents the bottom mold halve. However, those skilled in the pertinent art will recognize that the mold of the present invention is not limited to a specific orientation, and thus the orientation of the mold 30 as shown may be rotated along an imaginary central point to create a different orientation without departing from the spirit and scope of the present invention. The mold halves 32 and 34 oppose each other, and mate to form the mold 30. The first mold halve 32 has a main body 36 and the second mold halve 34 has a main body 38. A plurality of subgates 40 is disposed about the center of the mold at a parting line 41 of the mold 30. The parting line 41 represents the division between the first and second mold halves 32 and 34.

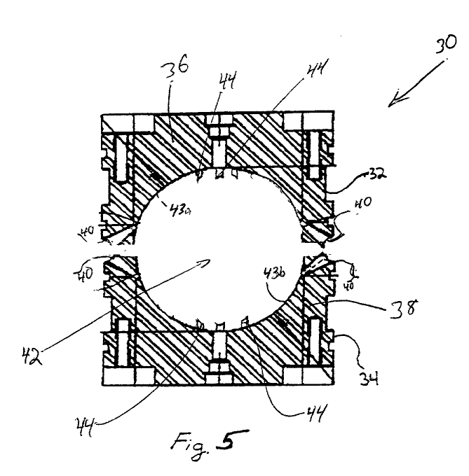

As shown in FIG. 5, the mold 30 has a substantially spherical internal cavity 42 that is defined by the concave internal surfaces 43a-b of the main bodies 36 and 38, respectively. The main bodies 32 and 34 may be composed of stainless steel, or the like to withstand the pressures generated during the molding operation. The internal surfaces 43a-b may be smooth as shown in FIG. 5 for molding of the intermediate layer 4 of the golf ball 1 of FIG. 1. Alternatively as shown in FIG. 5A, the internal surfaces 43a-b may have an inverse dimple pattern 46 thereon for modeling of the cover layer 6 of the golf ball 1 of FIG. 1. The inverse dimple pattern 46, although shown in portions, would actual cover most of the internal surfaces 43a-b.

Projecting from the internal surfaces 43a-b are a plurality of retractable pins 44. The plurality of retractable pins 44 assists in the centering of a golf ball core, or like, for the molding of an additional layer thereabout. The plurality of retractable pins 44 are located on both mold halves 32 and 34. Further, only one retractable pin 44 on each of the halves 32 and 34 may be needed to accomplish the function of centering the core in the internal cavity 42. The plurality of retractable pins 44 also function in the demolding of the product from the internal cavity 42 subsequent to the molding operation, as further described below. The retractable pins 44 retract and extend from corresponding apertures during the molding operation.

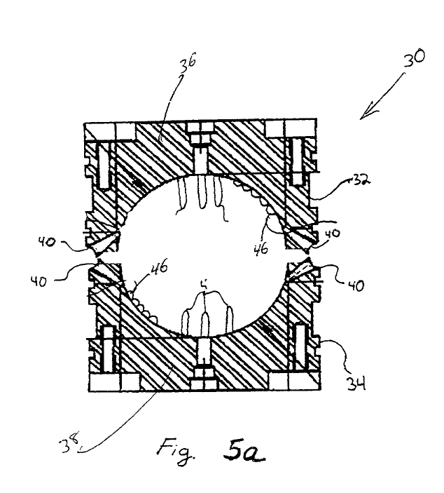

As shown in FIGS. 6-8, as well as FIGS. 4, 5 and 5A, the plurality of subgates 40 are unique in that each of the subgates 40 traverse the hemispherical mold halves 32 and 34 in a diagonal manner. The plurality of subgates 40 may be divided into a first plurality of subgates 40a disposed on the first hemispherical mold halve 32 and a second plurality of subgates 40b disposed on the second hemispherical mold halve 34. Each of the plurality of subgates 40 has an inlet 48 and an outlet 50. The inlet 48 is in flow communication with at least one of the mold runners 52 and 54. The mold runners 52 and 54 are channels that deliver the flowable material for the additional layer to each of the plurality of subgates 40. The runners 52 and 54 may be integrated with the mold 30 as shown in FIG. 6. Also, one runner may serve all of the plurality of subgates 40, or more than two runners may serve sets of the plurality of subgates 40.

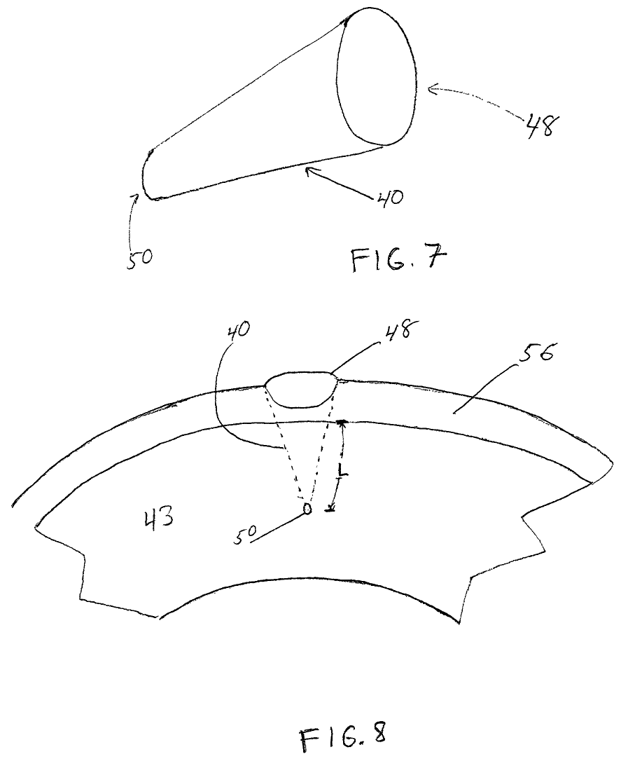

The inlet 48 of each of the plurality of subgates 40 is preferably located on an equatorial rim 56 on each of the mold halves 32 and 34. The equatorial rims 56 will correspond to the parting line 41 of the mold 30. The outlet 50 of each of the plurality of subgates will be a predetermined distance from the equatorial rim 56, along an arc of the internal surface 43. The predetermined distance, represented by “L” as shown in FIG. 8, may be in the range of 0.20 to 0.40 inches.

Each of the plurality of subgates 40 are tangentially oriented with respect to the inner surface 43 of the internal cavity 42. In this regard, the flowable material(not shown) injected through the each of the plurality of subgates 40 does not impinge upon the core 2 of the golf ball 1 in a perpendicular fashion. This tangential orientation results in decreased deformation, or bulging of the core 2 during the injection molding process. By moving each of the plurality of subgates 40 away from the parting line 41, the pressure is both reduced and is equalized to a certain extent by corresponding subgates 40 located on an opposing side of the hemispherical mold halves 32 and 34. Also, by having each of the plurality of subgates 40 enter the internal cavity 42 at a location away from the parting line 41, the distances required for the flowable material to reach the inverse polar regions, indicated by the dash line 58, are decreased. In addition, since the each of the plurality of subgates 40 are preferably tangentially oriented toward the polar region of the core 2, the flowable material is able to easily spread across the surface of the core 2 to reach the polar region rapidly. This further eliminates the pinching condition that might arise when injection molding a relatively thin cover 2 or intermediate layer 4.

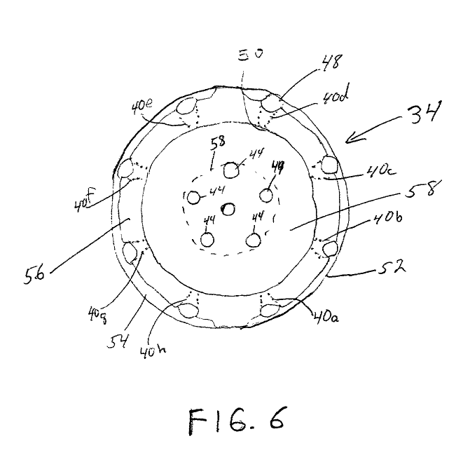

In the preferred embodiment, the inlet 48 of each of the plurality of subgates 40 has a radius that is larger than the corresponding outlet 50. As shown in FIG. 7, each of the plurality of subgates 40 preferably has a nozzle shape in which the narrower end of each of the plurality of subgates 40 enters the internal cavity 42. Preferably, the radius of the inlet 48 of each of the plurality of subgates 40 is about 0.085 inches. Preferably, the radius of the outlet 50 of each the plurality of subgates 40 is about 0.0135 inches. The nozzle shape of each of the plurality of subgates 40 not only increases the speed of the flowable material into the internal cavity 42, it also reduces the amount of vestigial remnants from each of the plurality of subgates 40.

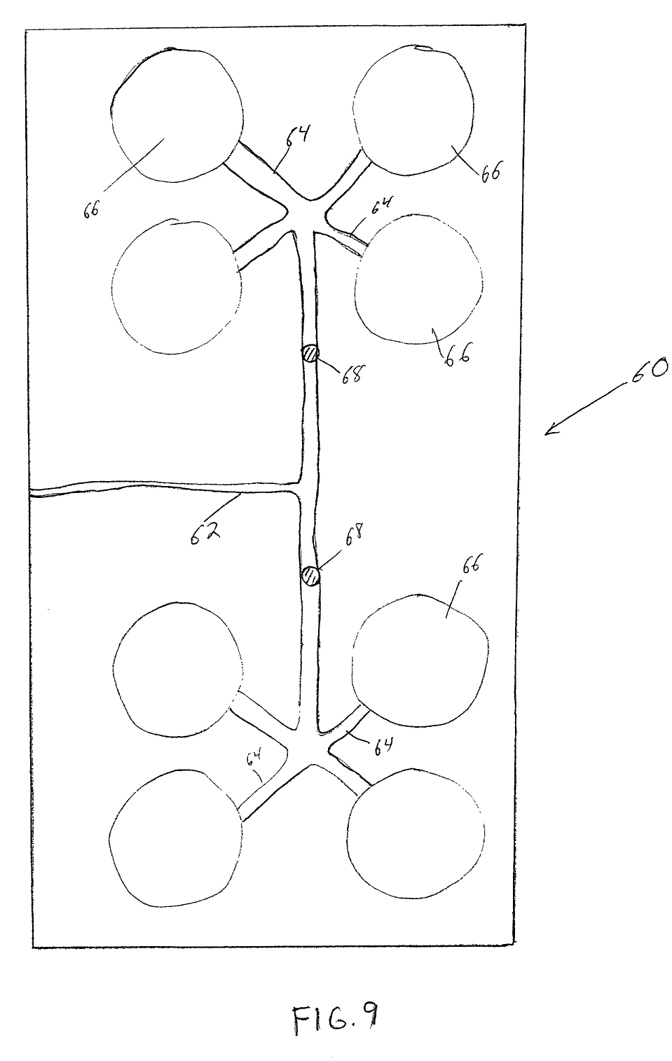

The number of subgates 40 may vary depending on the requirements of the injection molding process. Preferably, there are at least four subgates 40 per hemispherical mold halve 32 or 34. More preferably, there are eight per halve 32 or 34, as shown in FIG. 6, for a total of sixteen for the mold 30. As mentioned above, the flowable material is delivered to each of the plurality of subgates 40 via mold runners 52 and 54. As shown in FIG. 9, a mold base 60 has a central runner 62 that feeds the flowable material to ancillary runners 64. The ancillary runners 64 are in flow communication with the mold runners 52 and 54. A series of mold halves 32 or 34 will be disposed in the cavities 60 of the mold base 60 for mating with an opposing mold base 60 that will hold the other mold halves 32 or 34.

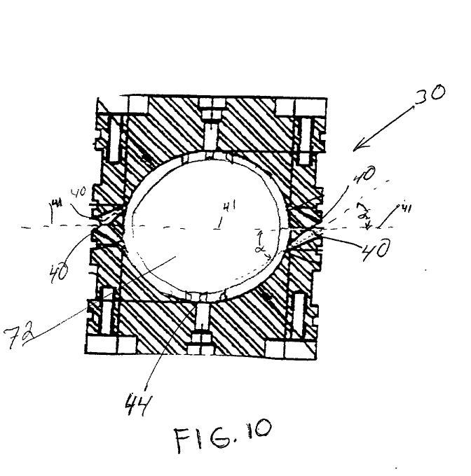

The molding operation for the present invention will be described in reference to FIGS. 10-13. As stated above, the tangential orientation of each of the plurality of subgates 40 causes decreased deformation of a golf ball precursor product 72 as well as improved flow properties over the surface of the golf ball precursor product 72. The golf ball precursor product 72 may be a core 2, or a core 2 with an intermediate layer 4. As can be seen in FIG. 10, an angle α is formed between a center line of each of the plurality of subgates 40 and the parting line 41. Preferably, the angle α is within the range of about 30° to about 40°. Most preferably, the angle α is about 37°. This advantageously permits the outlet 50 of each of the plurality of subgates 40 to open to the internal cavity 42 at about 0.25″ offset from the parting line 41 or equatorial rim. This particular range of angles α is preferred because the formation of nubs on the golf ball precursor product 72 is eliminated as discussed below. When angles outside of this range are used, post-injection molding processes are required to remove the nubs and other vestigial remnants from the golf ball precursor product 72.

As shown in FIG. 10, the golf ball precursor product 72 is centered within the internal cavity 42 by the plurality of retractable pins 44. The golf ball precursor product 72 is first placed within the second mold halve 34, and then the second mold halve is mated with the first mold halve 32. The void between the golf ball precursor product 72 and the surface 43a-b of the main bodies 36 and 38 will be filled with the flowable material to create the boundary layer 4 or a cover layer 6 of a golf ball 1. The flowable material is preferably a thermoplastic material, and more preferably a blend of ionomers. Such ionomers are sold under the name SURLYN by DuPont Chemicals and IOTEK by Exxon Chemicals. The flowable material also may be a thermoplastic elastomer. Those skilled in the pertinent art will recognize a multitude of materials that may be used in conjunction with the present invention.

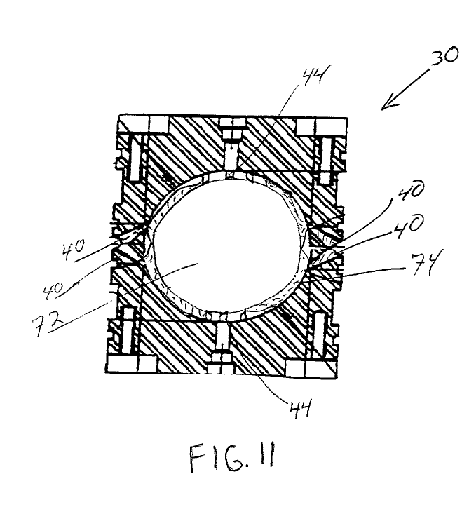

As shown in FIG. 11, at a subsequent stage of the molding operation, the flowable material, designated 74, is injected into the internal cavity to fill the void between the golf ball precursor product 72 and the surfaces 43a-b of the main bodies 36 and 38. The flow of the material 74 is directed toward the poles of the golf ball precursor product 72 which prevents, or at least reduces, the non-uniform pressure on the surface of the golf ball precursor product 72.

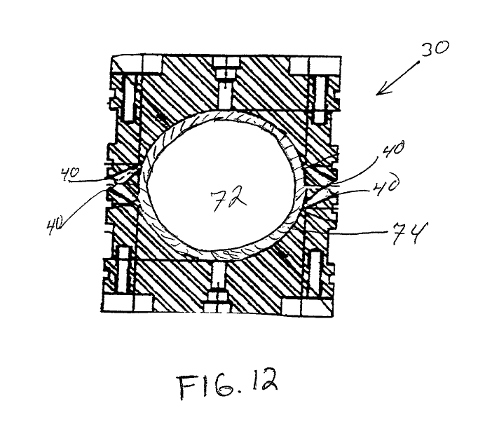

As shown in FIG. 12, the plurality of retractable pins are retracted to allow the flowable material to fill the area previously occupied by the plurality of retractable pins, and thus create a uniform layer about the golf ball precursor product 72. The new layer 76 of flowable material 74 is allowed to cure for a sufficient period of time depending on the flowable material utilized in the molding operation.

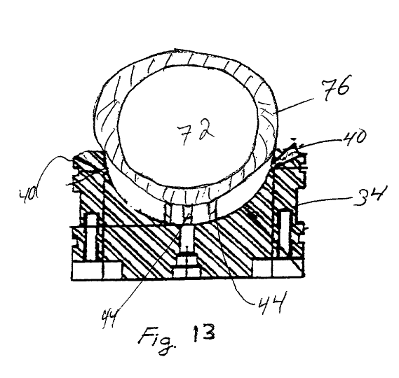

As shown in FIG. 13, the first mold halve 32 is removed from engagement with the second mold halve 34. Then each of the plurality of retractable pins 44 is extended to demold the molded product from the internal cavity 42. Each of the retractable pins 44 may extend at least two levels, one for centering of the golf ball precursor product 72, and one for demolding of the molded product. A plurality of runner pins 68, as shown in FIG. 9, will also extend for release of the excess material in the central runner 62. A mechanism for for extension of the pins 44 and 68 may include a bolt and slider, not shown, which engage the pins 44 and 68 from below the mold base 60. The bolt is adjustable to at least three positions, one for retraction, one for molding and one for demolding.

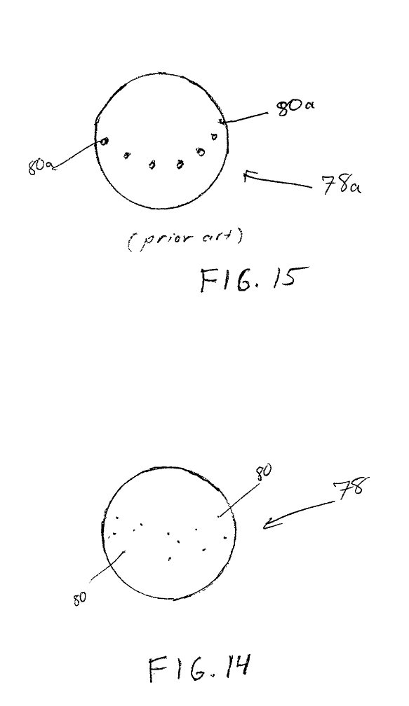

The forcing of the finished product from the second mold halve 34 by the extended retractable pins 44 allows for facilitated removal of the finished product from mold halve 34. The forcing prevents the inclusion of nubs 80 on the new layer 76 of the finished mold product since the forcing of the product cuts the remnants remaining inside the subgates 40 from the molded product 78. Further, the size of the outlets 50 facilitate the detachment of remnants and reduces the size of any nubs 80. As shown in FIGS. 14 and 15, the finished product 78 of the present invention only has insubstantial nubs which do not necessitate post-molding seam buffing or sanding for removal before further operations whereas the prior art product 78a has nubs 80a that require buffing or sanding. Additionally, the finished product 78 of the present invention may have a thinner layer as compared to injection molded layers of the prior art. Whereas the prior art is capable of producing layers having a thickness as thin as 0.050 inches, the present invention is capable of producing layers having a thickness as thin as 0.040 inches.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

I claim as my invention the following:

1. An injection mold device for manufacturing a golf ball, the injection mold device comprising:
a mold having a substantially spherical internal cavity defined by an internal surface of the mold, the mold having a plurality of subgates, each of the plurality of subgates having an inlet and an outlet, the outlet of each of the plurality of subgates disposed a predetermined length from a parting line of the mold and each outlet in flow communication with the internal cavity, each of the plurality of subgates oriented at a predetermined angle with respect to the parting line.

2. The injection mold device according to claim 1 wherein the mold further comprises a first mold halve and an opposing second mold halve, the first mold halve having a first set of the plurality of subgates and the second mold halve having a second set of the plurality of subgates, wherein the internal surface of the first mold halve defines a first hemispherical cavity of the spherical cavity and the internal surface of the second mold halve defines a second hemispherical cavity of the spherical cavity.

3. The injection mold device according to claim 1 wherein each of the plurality of subgates is oriented at an angle between 30 and 40 degrees with respect to the parting line.

4. The injection mold device according to claim 1 wherein the outlet of each of the plurality of subgates is between 0.20 and 0.30 inches from the parting line.

5. The injection mold device according to claim 1 wherein the mold further comprises at least one mold runner, the inlet of each of the plurality of subgates in flow communication with at least one annular runner.

6. The injection mold device according to claim 5 further comprising a first mold base halve and a second mold base halve, at least one of the first and second mold base halves having a central runner in flow communication with the at least one mold runner.

7. The injection mold device according to claim 1 wherein the plurality of subgates is sixteen subgates.

8. The injection mold device according to claim 2 wherein the first set of the plurality of subgates lies on a first plane and the second set of the plurality of subgates lies on a second plane parallel to the first plane.

9. The injection mold device according to claim 1 wherein the inlet has a diameter larger than the diameter of the outlet for each of the plurality of subgates.

10. The injection mold device according to claim 1 wherein the mold further comprises a plurality of retracable pins.

11. An injection mold device for manufacturing a golf ball comprising:
a first mold halve having a concave surface defining a first hemispherical cavity, the concave surface having an equatorial rim defining the top of the first hemispherical cavity and an inverse pole defining the bottom of the first hemispherical cavity, the first mold halve also having a first plurality of subgates, each of the first plurality of subgates having an inlet and an outlet, the outlet of each of the first plurality of subgates disposed a predetermined length from the equatorial rim and each outlet in flow communication with the first hemispherical cavity, each of the first plurality of subgates oriented at an angle between 30 and 40 degrees with respect to the equatorial rim; and
a second hemispherical mold halve opposing the first hemispherical mold halve, the second hemispherical mold halve having a concave surface defining a second hemispherical cavity, the concave surface having an equatorial rim defining the top of the hemispherical cavity and an inverse pole defining the bottom of the hemispherical cavity, the second hemispherical mold halve having a second plurality of subgates, each of the second plurality of subgates having an inlet and an outlet, the outlet of each of the second plurality of subgates disposed a predetermined length from the equatorial rim and each outlet in flow communication with the hemispherical cavity, each of the second plurality of subgates oriented at an angle between 30 and 40 degrees with respect to the equatorial rim.

12. The injection mold device according to claim 11 wherein the first plurality of subgates and the second plurality of subgates are symmetrical about an imaginary plane passing through a parting line that divides the first hemispherical mold halve from the second hemispherical mold halve.

13. The injection mold device according to claim 11 wherein the outlet of each of the first plurality of subgates is between 0.20 and 0.30 inches from the equatorial rim of the first hemispherical mold halve, and the outlet of each of the second plurality of subgates is between 0.20 and 0.30 inches from the equatorial rim of the second hemispherical mold halve.

14. The injection mold device according to claim 11 further comprising at least one mold runner in flow communication with the first plurality of subgates and the second plurality of subgates.

15. The injection mold device according to claim 14 further comprising a first mold base halve and a second mold base halve, at least one of the first and second mold base halves having a central runner in flow communication with the at least one mold runner.

16. The injection mold device according to claim 15 further comprising at least one extendable runner pin disposed within the central runner.

17. The injection mold device according to claim 11 further comprising at least one retractable pin disposed at the inverse pole region of each of the first and second hemispherical mold halves.

18. The injection mold device according to claim 11 wherein the inlet of each of the first and second plurality of subgates has a radius larger than the radius of the outlet of each of the first and second plurality of subgates.

19. The injection mold device according to claim 11 wherein each of the concave surfaces of the first and second hemispherical molds has an inverse dimple pattern thereon.

20. A method for molding a layer for a golf ball, the method comprising:
injecting a flowable material about a golf ball precursor product disposed within an internal cavity of a mold, the mold comprising a first hemispherical mold halve and an opposing second hemispherical mold halve, the flowable material injected through a plurality of subgates disposed a predetermined distance from a parting line defining the meeting of the first and second hemispherical mold halves, each of the plurality of subgates oriented at an angle between 30 and 40 degrees relative to the parting line.

21. The method according to claim 20 further comprising:
removing the first hemispherical mold halve after forming a layer of flowable material about the golf ball precursor product thereby creating a molded golf ball product; and
extending at least one retractable pin to move the molded golf ball product partially from the second hemispherical mold halve thereby cutting any remanants on the layer of flowable material.

22. The method according to claim 20 wherein the flowable material is a thermoplastic material.

23. The method according to claim 22 wherein the thermoplastic material is a blend of ionomers.

24. The method according to claim 21 further comprising:
extending the at least one retractable pin to a partial extension position;
placing a golf ball precursor product on the least one retractable pin; and
mating the first hemispherical mold halve with the second hemispherical mold halve prior to injecting the flowable material.

25. The method according to claim 24 wherein the golf ball precursor product is a core and the layer of flowable material is a boundary layer.

26. A golf ball precursor product having an injection molded layer without substantial remanants thereon, the golf ball precursor product produced in accordance with the method comprising:
injecting a flowable material about a core disposed within an internal cavity of a mold, the mold comprising a first hemispherical mold halve and an opposing second hemispherical mold halve, the flowable material injected through a plurality of subgates disposed a predetermined distance from a parting line defining the meeting of the first and second hemispherical mold halves, each of the plurality of subgates oriented at an angle between 30 and 40 degrees relative to the parting line.
